(19) United States
(12) Patent Application Publication
(10) Pub. No.: US 2013/0152517 A1
(43) Pub. Date: Jun. 20, 2013

(54) Saddle Pad, In Particular For Use As A Pad For A Western Saddle

(71) Applicant: Brian Kronborg JESPERSEN, Hjallerup (DK)

(72) Inventor: Brian Kronborg JESPERSEN, Hjallerup (DK)

(21) Appl. No.: 13/326,577

(22) Filed: Dec. 15, 2011

(51) Int. Cl. B68B 1/00

(52) U.S. Cl. 54/66

(57) ABSTRACT

A saddle pad, in particular for use as a pad for a western saddle, has a felt cover (2), in which two pockets are formed, an air cushion (8, 8′) is inserted into each pocket (7, 7′) located on each side of a central line of the pad. Each cushion partly fills at least a front half of the pocket and partly is provided with barrier walls (13, 14, 15 and 13′, 14′, 15′) extending from a rear wall of the cushion and a distance forwardly, such that the engagement pressure from the saddle on the horse will be reduced, and at the same time the rider will remain in good contact with the horse.

### TECHNICAL FIELD

The invention relates to a saddle pad, in particular for use as a pad for a western saddle, and comprising an upper member preferably made of felt and an associated lower member, which are stitched together to form two cavities, said cavities extending in the longitudinal direction of the pad and being disposed mirror-symmetrically with a cavity on each side of the central line of the pad, and with a flexible air-tight cushion arranged in each cavity, said cushions being provided with an air valve for air filling and pressure regulation.

A saddle pad of this type serves to keep the saddle clean and also to absorb the sweat, which would otherwise make the saddle slippery, involving the danger that it will slide on the horse.

### BACKGROUND

There is a special need for a pad when riding in a so-called western saddle, as the special configuration of this saddle makes it heavy and moreover stiff to enable it to withstand the pull from a lasso, when this is secured to the saddle knob, the horn.

The weight and the stiffness often result in pressure injuries on the horse, and since the stiff configuration has a limited contact face with the back of the horse, there will a great risk of so-called pressure injuries on the horse.

It is known to provide saddle pads with pressure absorbing and pressure distributing pads inserted into a saddle pad. Thus, it is known from U.S. Pat. No. 7,137,236 to insert a foam cushion (20) in the pad, said cushion absorbing and distributing the weight.

This solution, however, is not suitable for riding in a western saddle, since the contact with the horse is transferred as a resilient and thereby “soft” contact, which is inexpedient. To this should be added that the pressure absorbing capacity of the cushions will be impaired after a short period of use, because the foam will be compressed to the detriment of the pressure distribution, which will be reduced correspondingly.

To remedy this defect, it is known from European Patent No. EP 1 837 302 A1 to insert an air-filled cushion (2) into the pad on each side of the central line.

These two cushions will be able to distribute the weight, but this solution, too, is not suitable for use when riding in a western saddle. The air in the cushion will be distributed such that there will be the least amount of air where the pressure is greatest such that the saddle and thereby the rider will feel as if he was sitting on an air cushion. This feeling of a swimming or rocking riding makes the pad unsuitable for use below a western saddle.

### OBJECTS OF THE INVENTION

It is an object of the invention to remedy these defects and drawbacks of known pads, and this is achieved according to the invention by a pad, wherein each cushion is attached to a flexible carrier member, each of which is capable of filling a cavity and such that each cushion fills at least the front half of each cavity.

In this surprisingly simple manner, the tendency of the air to “disappear” where the pressure is greatest, is reduced, as the cushion is disposed in the front part of the pad and, thus, is disposed exactly at the location where the pressure impact is greatest, and where the need for pressure distribution is present. Thereby, the contact between rider and horse is maintained as best as possible, since the desired contact between rider and horse is maintained.

When the cushion is provided with barrier walls, the tendency of the air to move in the cushion, viz. away from the pressure area, will be additionally limited, as the walls will serve as boundaries for the movement of the air in the cushion.

When the walls are disposed in parallel with the central line of the pad, and the extent of the cushion downwards at the rear is moreover limited, the air cushions will be disposed at the most effective locations, viz. where the saddle rests and presses against the back of the horse.

When the barrier walls extend along about one half of the length of the cushion, wave motions of the air will be limited as much as possible.

When the barrier walls are formed by stitching the opposed cushion walls together, it will be ensured that the cushions do not get too bulky, that is thick, and also that they remain relatively flat.

When the cushions are made from an air-tight sheet, either in the form of plastics or rubber, the assembly to form the walls may take place by hot melting or vulcanization.

Finally, it is expedient that the amount of air in the cushions may be regulated in response to the weight and the load as well as in part according to the shape of the back of the horse relative to the shape of the saddle.

### BRIEF DESCRIPTION OF THE DRAWINGS

An example of an embodiment of a saddle pad according to the invention will be described more fully below with reference to the drawing, in which:

FIG. 1 shows a saddled horse with western saddle and pad according to the invention;

FIG. 2 shows the pad seen toward its lower side;

FIG. 3 shows the pad with open cavities and inserts in the form of carrier layer and air cushion prior to the insertion into the cavity;

FIGS. 4 and 6 show a portion of the carrier layer with left and right cushions, respectively;

FIGS. 5 and 7 show a sectional view of left and right cushions, respectively, seen in the direction V-V in FIG. 4 and VII-VII in FIG. 6; and,

FIG. 8 shows a horse with the pad seen from above.

### DETAILED DESCRIPTION OF THE INVENTION

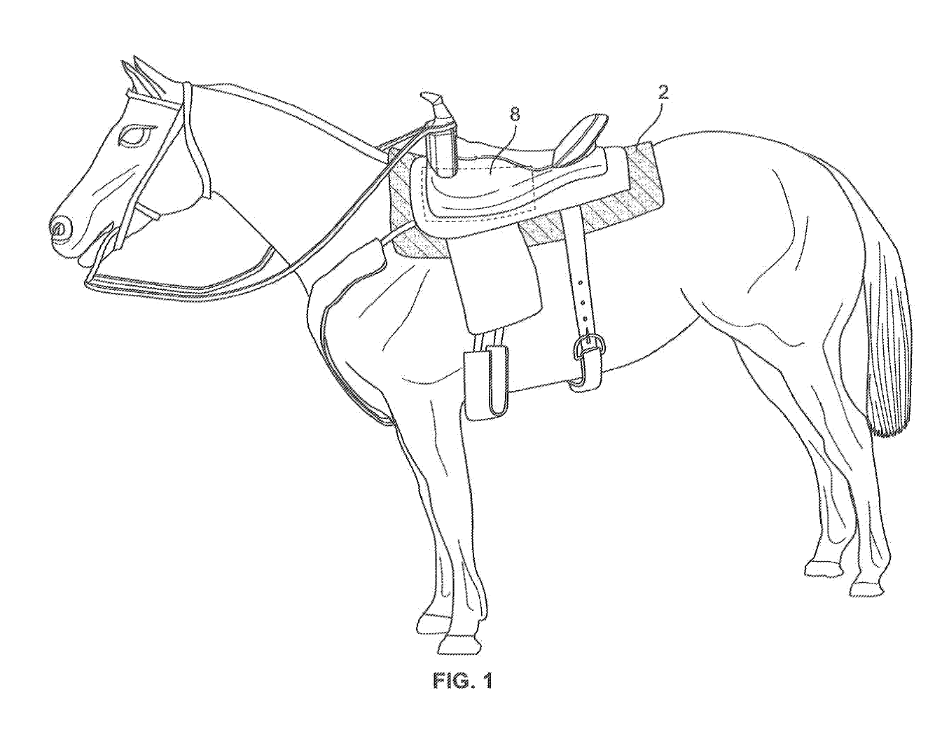

The invention will be described below on the basis of an example of a saddle pad 2, which, as shown in FIG. 1, is used in connection with a western saddle.

Such a saddle is characterized in that it is a stiff saddle in contrast to a leather saddle, and provided at the front with a horn at the center at the seat and a cantle.

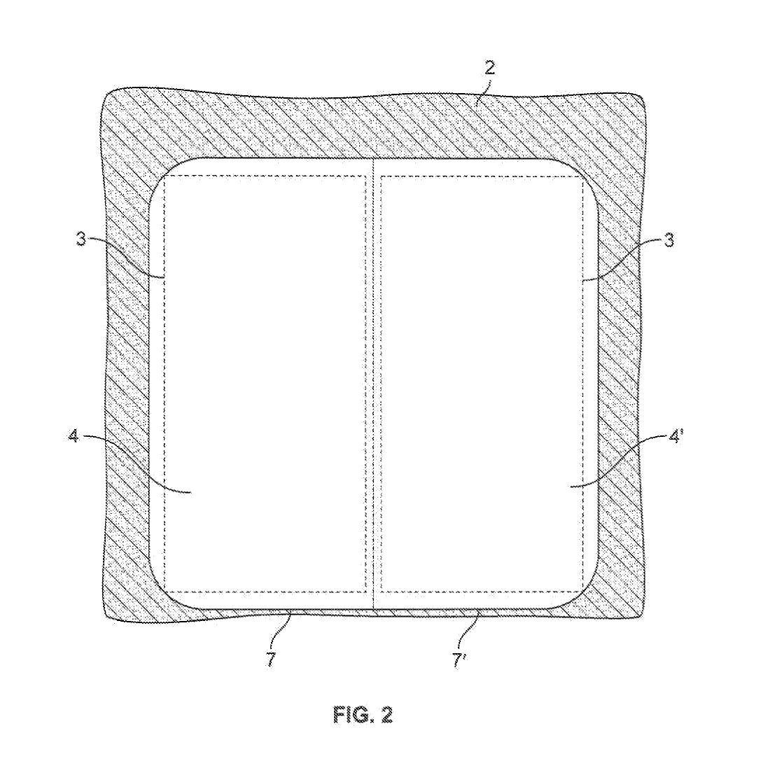

The pad 2 is shaped with a so-called schabrack shape, which is a four-sided shape, as shown in FIG. 2.

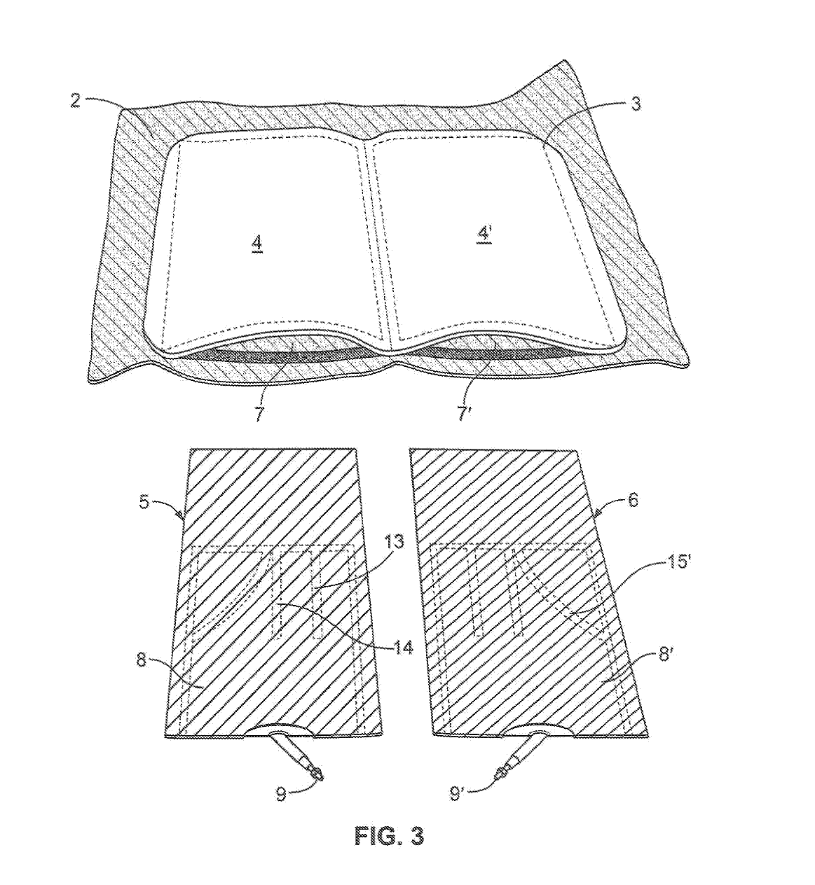

The pad comprising an upper layer and a lower layer is preferably made of a strong felt layer and, on the lower side, is provided with layers 4 and 4′, which are stitched together, as indicated by a dashed line 3. As shown, this stitching extends along the lateral edges of the pad. Where it is desired to have the option of exchanging the air cushions, the front end edges, which are not stitched together, may be provided with some form of closure, such as a Velcro® hook and loop type releasable closure, as indicated in FIG. 3.

Hereby, the upper layer and the lower layer form two cavities or pockets, 7 and 7′, into which the carrier members 5 and 6, shown in FIG. 3, may be inserted, each of said carrier members being provided with a flexible cushion 8 and 8′ which essentially has an extent corresponding to about one half of the carrier member 5 and 6.

The flexible cushion is secured to the carrier member and dimensioned such that the carrier member with cushion is capable of filling a cavity in the pad.

Each cushion 8 and 8′ is made of an air-tight material, so that they may be inflated via a valve 9 and 9′. The purpose of these cushions is to absorb and distribute the pressure which is exerted by the saddle on the back of the horse. This provides protection against pressure injuries, just as the engagement of the saddle with the horse may be adapted by a suitable selection of the air pressure.

To ensure the desired contact between rider and horse, however, the saddle must be secured to the horse more or less immovably.

This is a requirement for the pad to operate in connection with a western saddle.

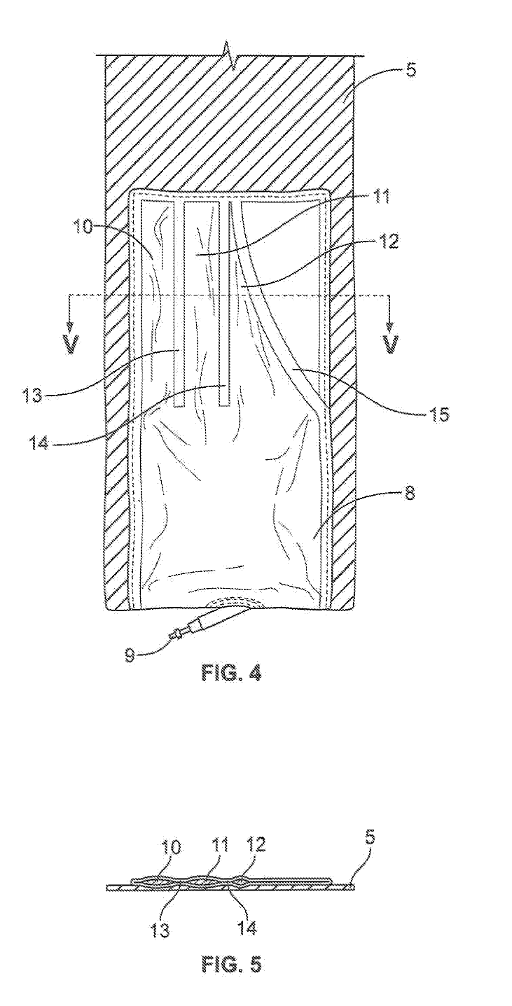

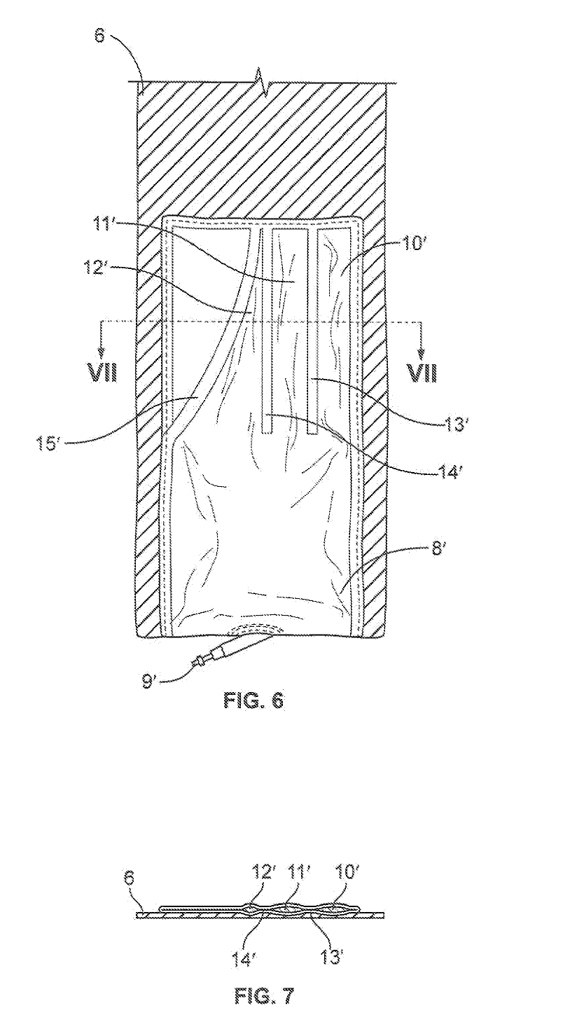

Therefore, as shown in FIGS. 4-7, the air cushions are provided with a cavity disposed at the front, said cavity being positioned at the contact area between the saddle and the horse, and with two partition walls 13, 14 and 13′, 14′ at the rear extending in parallel in the example shown.

These walls serve to limit the moment of the air during riding, as they partly reduce the volume in which the air is present and partly limit the flow between the various areas 11, 12 and 11′, 12′ in the cushion. Hereby, the air movements and the air flows are dampened, and the rider feels that there is a firm contact with the horse.

FIGS. 4 and 6 moreover show a barrier wall 15 and 15′, which extend between the rear side and the lowermost lateral edge. These walls serve to reduce the volume of air so that air will primarily be present where the engagement pressure is.

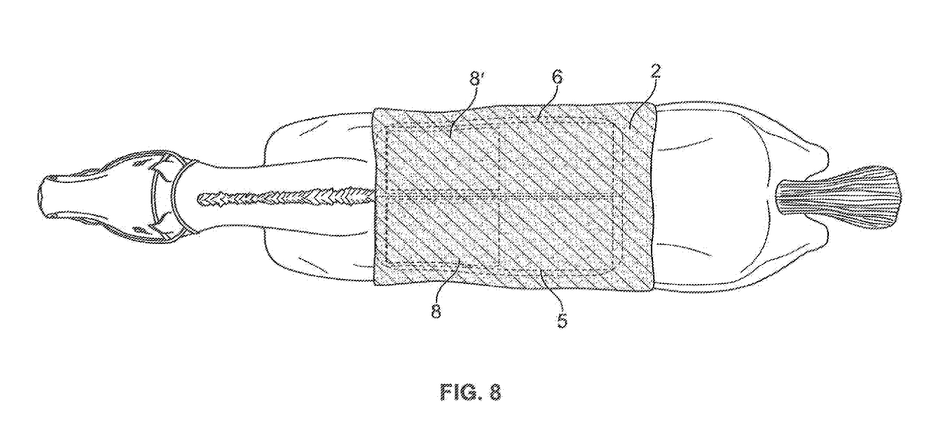

FIG. 8 shows the position of the two cushions in the pad with the described partition walls and boundary walls.

Valves 9 and 9′ are mounted for the regulation of the air pressure and/or the air volume in the cushions, said valves serving to supply air to the cushions and to allow the air pressure/air amount to be adjusted, such that the pressure from the saddle is distributed as best as possible across the back of the horse. This protects the horse against pressure injuries, and it is moreover ensured that the blood flow of the horse in the skin remains intact, thereby completely avoiding pressure sores.

The example shown includes partition walls extending in parallel and a boundary wall extending obliquely, but, of course, there may be more or fewer depending on the need for regulation of the air flow and the configuration of the air compartments of the cushion. This makes it possible to adapt the pad to the horse and the shape and size of the saddle.

I claim:

1-8. (canceled)

9. A saddle pad for use beneath a western saddle, comprising:
an upper member and an associated lower member, which are stitched together to form two cavities, said cavities extending in a longitudinal direction of the pad and being disposed mirror-symmetrically, with a cavity located on each side of a central line of the pad,
a pair of flexible inflatable cushions configured for residing in a portion of each cavity, each flexible inflatable cushions being provided with an air valve for filling each flexible inflatable cushion with air,
each cushion being attached to a flexible carrier member, each cushion and attached carrier member being configured for filling a cavity, each cushion positioned on each carrier member such that when inserted into a respective cavity, the cushion is located within a front half of each cavity, and thereby in a front part of the pad, at a location where a pressure from a rider has the greatest impact, and,
each flexible inflatable cushion including internal dampening structures for dampening internal air flows within the cushion, pressure exerted on the cushion from a saddle placed on the pad being absorbed and more evenly distribute onto the back of a horse thereby, while assuring that the rider feels firm contact with the horse.

10. The saddle pad according to claim 9, wherein the dampening structures comprise one or more barrier walls arranged in a rear portion of each cushion, said barrier walls extending from a rear wall of the cushion forwardly, said barrier walls defining air receiving areas within the interior of the cushion, said barrier walls partly reducing an air receiving volume of the cushion and partly limiting air flow between the defined areas in the cushion.

11. The saddle pad according to claim 9, wherein the dampening structures comprise at least a first barrier wall which extends essentially in parallel with the central line of the pad, and at least a second barrier wall which extends between a rear wall of the cushion and a lowermost lateral wall of the cushion.

12. The saddle pad according to claim 10, wherein the one or more barrier walls have a length which essentially corresponds to half the length of the cushion.

13. The saddle pad according to claim 11, wherein the first and second barrier walls each extend forwardly for a length which essentially corresponds to half a length of the cushion.

14. The saddle pad according to claim 10, wherein the one or more barrier walls are formed by fixing together opposed upper and lower surfaces of the cushion.

15. The saddle pad according to claim 9, wherein each cushion is made from an air-tight sheet.

16. The saddle pad according to claim 9, wherein each air valve is configured for adjusting an amount of air contained in each cushion.

17. The saddle pad of claim 9 wherein the upper member is made of felt.
